(19) United States
(12) Patent Application Publication
(10) Pub. No.: US 2009/0140004 A1
(43) Pub. Date: Jun. 4, 2009

(54) Dispensing Apparatus

(76) Inventor: Iain Scorgie, London (GB)

Correspondence Address: HEAD, JOHNSON & KACHIGIAN, 228 W 17TH PLACE, TULSA, OK, 74119, US

(21) Appl. No.: 11/921,589

(22) PCT Filed: Mar. 28, 2006
(86) PCT No.: PCT/GB2006/001108

§ 371 Date: Feb. 7, 2008

(30) Foreign Application Priority Data
Jun. 16, 2005 (GB) 0512258.5

(51) Int. Cl. B67D 5/08; B67D 5/22; B67D 5/00; B05B 11/00; G01F 11/00

(52) U.S. Cl. 222/52; 222/78; 222/325; 222/36; 222/39; 222/181.3; 222/638

(57) ABSTRACT

This invention provides a liquid dispensing apparatus such as, for example, a liquid soap dispensing apparatus. The apparatus can be provided as a self-contained unit including a reservoir provided at a spaced location from a base. Sensor means are provided to allow the selective dispensation of liquid from the reservoir upon the detection of a part of a user's anatomy in a position between the liquid reservoir and the base. A motor can be connected to an outlet from the liquid reservoir which allows a portion of the liquid to be dispensed in a controlled manner, and the power source for the motor is typically a battery or batteries and the same are located in the base. The provision of the batteries in the base, a position remote from the liquid reservoir, protects the batteries from the liquid and means that the liquid reservoir need not be provided with a sealing cap to prevent liquid from entering the power source and damaging the same.

### CROSS-REFERENCES TO RELATED APPLICATIONS

This application is the United States National Phase of PCT Application No. PCT/GB2006/001108 filed 28 Mar. 2006 which claims priority to British Application No. 0512258.5 filed 16 Jun. 2005.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention to which this application relates is apparatus to allow for the dispensation, selectively, of a liquid such as, but not necessarily exclusively, a liquid gel or soap for use in cleaning hands or other parts of the anatomy.

The provision of apparatus which allows for the dispensing of liquid gel (hereinafter referred to as liquid soap in a non-limiting manner) from containers is well known. The conventional apparatus typically takes two forms.

The first is a mechanical form in which there is provided a nozzle at the top of the bottle which can be operated manually, typically by depression, to cause a pumping action, and a portion of the liquid soap held in the container is ejected from the nozzle outlet. This form of dispenser requires physical manipulation by a user and can be time consuming and/or difficult for certain persons, such as the young or elderly, to perform the manual manipulation.

An alternative conventional form is that which is used in commercial premises as part of the fixtures and fittings of a washroom which are used by a large number of the public. As part of the washing facilities, there may be provided a liquid soap dispenser which can be automatically or manually operated.

In either case, the apparatus, because the same is required to be used by large numbers of the public and may not be used in a careful manner, has to be designed to a completely different standard to that which would be provided for domestic use and, therefore, the size, expense and general design is impractical for use in domestic purposes. Smaller, non-domestic powered dispensing devices which are known all incorporate a power source housing, such as for batteries which are positioned adjacent the liquid reservoir. This therefore means that in normal use and/or when refilling the reservoir there is a problem of ingression of liquid from the reservoir into contact with the power source. This can damage the power sources and/or connections and hence cause the failure of the product. Conventionally, the approach to overcoming this problem has been to provide relatively expensive sealed housings for the power source and/or to provide sealed lids for the reservoir so as to try and prevent and resist the transfer of the liquid. However, the sealed lids can be difficult to open to refill of the reservoir, especially by children or the infirm, and the size of the sealed lids and housings mean that the overall size of the product is increased and/or the possible size of the liquid reservoir capacity is reduced, as well as increasing the expense of the product. This increase in expense can make the seam commercially unfeasible for domestic use.

A problem which is experienced in domestic premises and, in particular, by parents at bath time for young children, is when they are attempting to bath the child who may not want to be bathed and who may prove to be particularly difficult. An underlying aim of the present invention is to provide apparatus which would be an aid to a parent in dispensing liquid soap when required by the parent and with a minimum effort being required by the parent, therefore allowing them to continue to control their child and for the product to be repeatably usable over a period of time.

A further aim of the present invention is to provide apparatus which is of a form that is attractive for the child to use and, thereby, encourage the child to use the apparatus by themselves and thereby encourage the child to perform washing operations without parental supervision.

### BRIEF SUMMARY OF THE INVENTION

In a first aspect of the invention, there is provided apparatus for the selective dispensation of a liquid, the apparatus including a base, a reservoir of the liquid to be dispensed which is spaced from the base, a dispensing means through which a quantity of liquid can be dispensed from the reservoir into a dispensing region between the base and the reservoir, a power source, and sensing means to control the dispensing of the liquid upon detection of a person and wherein the power source is provided at a position on the apparatus below the dispensing means.

Typically, the liquid is for use in cleaning parts of a person's anatomy and is dispensed onto a person's hand or other part of the anatomy or an item held by the person and positioned in the dispensing region.

Typically, the power source is provided within or adjacent to the base. In one embodiment, the power source is located in a housing which is accessible through an opening on a face of the base other than a face of the base which faces towards the dispensing means.

Typically, the power source is located in a housing remote from the liquid reservoir so as to prevent the liquid from contacting the power source.

Typically, the power source comprises one or a plurality of batteries.

By providing the power source in the base or at least below the dispensing means, so the same can be removed from the liquid reservoir to a sufficient extent that any liquid which is emitted from the reservoir cannot contact the power source. This therefore means that the conventional need for sealing means for the power source housing and/or reservoir opening is reduced or removed and therefore reduces the cost of the product, allows the product to be reduced in size and/or for the liquid reservoir capacity to be increased and/or for access to be gained to the reservoir more easily.

It also, importantly, allows the function of the dispensing apparatus to be more reliable as the risk of failure of the power source or the power source connections due to the liquid ingress is reduced.

In one embodiment, the sensing means detect the presence of a hand or other part of a person's anatomy and when said presence is detected, a quantity of the liquid is dispensed. Typically, the apparatus can be selectively activated, and only when the apparatus is activated is the sensor active and the liquid can be dispensed as required.

In one embodiment, the apparatus includes dispensing adjustment means which allow the user to select the quantity of the liquid which is dispensed on each occasion. For example, if the apparatus is to be used by a child, he/she will require less liquid than an adult and the apparatus can be adjusted according.

Typically, the sensor is an infra red sensor which detects the presence of heat generated by the person's anatomy within a given range of the sensor.

In one embodiment, control means are provided for the dispensing means which ensure that a quantity of liquid is dispensed for a predetermined period of time or, alternatively, a particular volume of liquid is dispensed. Typically, once the sensor has been activated by the detection of a person's anatomy and a portion of liquid dispensed, a time interval is required to elapse before a further quantity of liquid will be dispensed. This is to prevent the possibility of, for example, a child keeping his/her hands in the vicinity of the sensor even after a portion of the liquid has been dispensed and thereby causing, in quick succession, a series of dispensations of liquid which is not required.

In one embodiment, the liquid reservoir is provided as an integral part of the apparatus and can be refilled by pouring of liquid from a refill container into the reservoir. In this arrangement, the reservoir could be filled by the user with a particular liquid of choice and, therefore, the apparatus is not specific to a particular product. This therefore would allow particular types of liquid to be provided to suit particular skin types and/or particular allergic conditions.

In an alternative embodiment, the reservoir is the bottle or container in which the liquid is purchased, and the apparatus includes engagement means which allow the opening or mount of the container or bottle to be attached to the apparatus and act as the reservoir for the apparatus.

In one embodiment, the apparatus includes a drip or collection tray positioned below the dispensing means outlet so as to act as a collector for excess liquid which has been dispensed. In one embodiment, the drip tray is removable to allow the same to be emptied.

The apparatus is provided as a self-contained unit which can be positioned to suit particular bathroom environments and in a most convenient position for use.

The apparatus includes attachment means which allow the attachment of the apparatus via the base to a support surface and/or the side walls so as to locate the apparatus in position for use.

Typically, the apparatus can be provided of a form and design to suit particular targeted users and may, in one embodiment, incorporate a character design and thereby lend use of the apparatus for character licensing.

In one embodiment, in addition to causing the activation of the dispensing means, the operation of the sensor, when it detects the presence of a hand or the like, causes the operation of visual and/or audible means provided as part of the apparatus, thereby adding to the attractiveness of the application.

In one embodiment, the apparatus can include a counter device which provides an indication of the number of uses of the apparatus in terms of the dispensing of liquid.

In one embodiment, any adjustment means which allow control or alteration of operation of the apparatus can be provided within a cavity which is covered over and may only be accessible by an adult or authorized person.

In one embodiment, the apparatus includes power sources in the form of any or any combination of battery, mains, or solar power.

In an alternative or in addition to the use of an infra red sensor, the apparatus may be operated to dispense liquid in response to a user voice signal, thereby allowing voice or noise actuation.

In a further aspect of the invention, there is provided apparatus for the selective dispensation of a liquid, of a type to aid the cleaning of part of a person's anatomy. The apparatus includes a reservoir of the liquid to be dispensed, a dispensing means through which a quantity of the liquid can be dispensed, a power source, and sensing means to control the dispensing of the liquid in response to a user's presence being detected to allow the liquid to be dispensed on to the person for use.

In a yet further aspect of the invention, there is provided apparatus for dispensing a liquid for the cleaning of part of a person's anatomy. The apparatus includes a base, a reservoir of the liquid to be dispensed, a dispensing means through which a quantity of liquid can be dispensed from the reservoir, a power source, and sensing means to control the dispensing of the liquid upon detection of the presence of a part of a person's anatomy in the dispensing region for the liquid. The power source is provided within or adjacent to the base.

### BRIEF DESCRIPTION OF THE DRAWINGS

Specific embodiments of the invention are now described with reference to the accompanying drawings.

FIGS. 1a-g illustrates a first embodiment of the invention in elevation.

FIGS. 2a to g illustrate alternative embodiments of the invention.

FIGS. 3a to d illustrate the utilization of the invention in one embodiment.

FIGS. 4a and b illustrate possible designs incorporated into the apparatus in accordance with the invention.

FIG. 5 is an exploded diagram of the apparatus of FIGS. 1a-g.

### DETAILED DESCRIPTION OF THE INVENTION

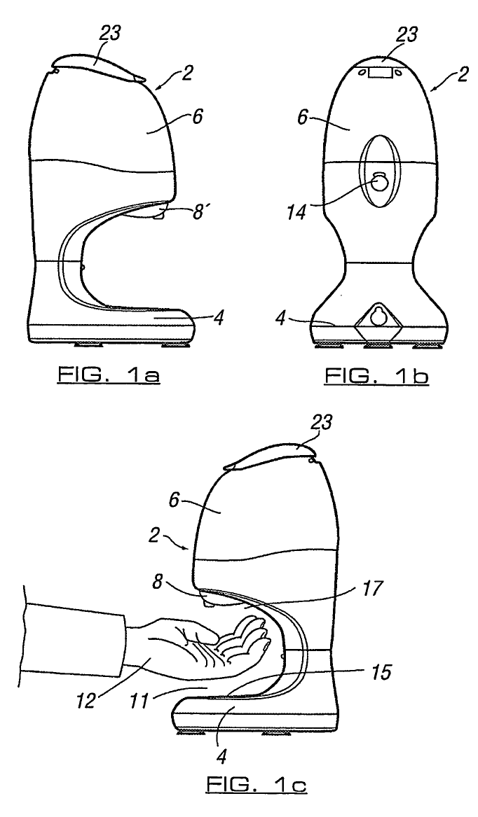

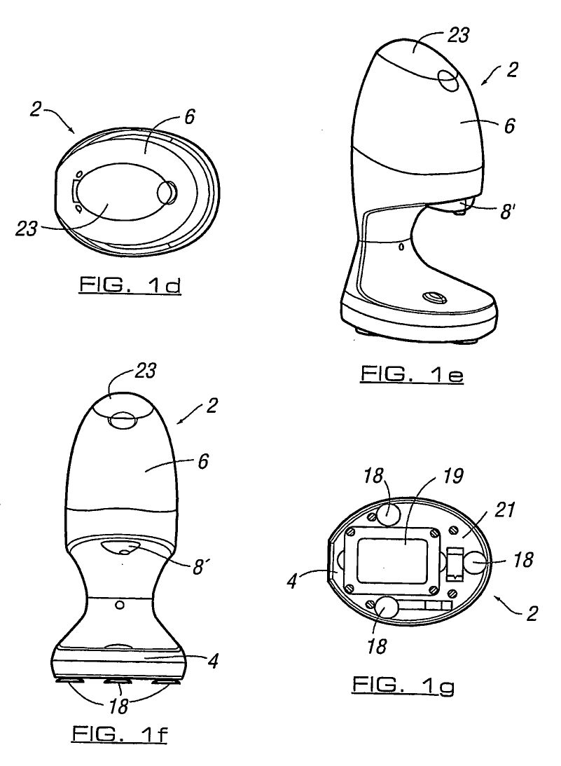

Referring first to FIGS. 1a-g, there is illustrated apparatus 2 in accordance with one embodiment of the invention. The apparatus is herein described with reference to the dispensation of liquid soap, although it should be appreciated that any substance which is suitably fluid can be dispensed, such as toothpaste, gel or the like. While it is envisaged that the apparatus is of particular benefit to use in bathrooms, it is possible that other uses of the apparatus in other areas are possible and, therefore, the description herein provided should not be interpreted as limiting the potential use of the apparatus or the scope of protection afforded therefore.

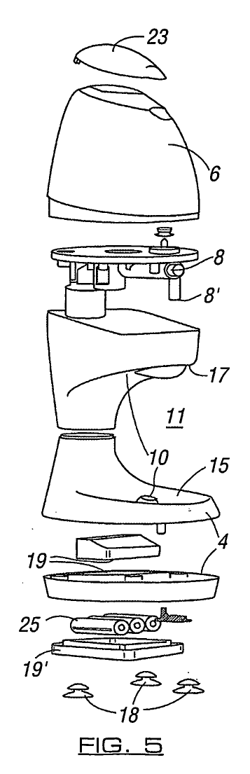

In the example shown in FIGS. 1a-g, apparatus 2 includes a base unit 4, the underside of which is shown in FIG. 1g. The base unit 4 is connected to mount a reservoir 6 which holds the liquid to be dispensed. A dispensing means 8 including a motor or pump (not shown) and a dispensing outlet 8′ leading from reservoir 6 are positioned underneath the reservoir and so allow the motor to be selectively operated to allow the dispensation of a portion of liquid through the outlet and to do so in conjunction with gravity feed from the reservoir. This means that the size and power consumed of the motor can be minimized as the motor does not have to pump the liquid against the gravity at any time, as the liquid in the reservoir is always above the outlet. Sensing means 10 is provided in the vicinity of the liquid outlet so as to sense the presence of part of a person's anatomy, in this case, a user's hand 12 in a dispensing region 11 which is the gap between a top side 15 of base 4 and an underside 17 of the reservoir holder, as shown in FIGS. 1c and 5. The sensing means is positioned and of a strength so as to detect when a person's hand is in the correct area for receiving liquid from outlet 8′, such that the liquid will land on the person's hand rather than missing the same. The apparatus can be selectively moved into an active condition via an on/off switch 14. When the switch is in the “on” position, a power source, typically batteries 25 provided within a housing 19 with a lid 19′ in the underside 21 of the base, supply power to the sensing means and to the motor thereby allowing the same to be active. Detection by the sensing means causes operation of the dispensing means by activation of the motor or pump which causes a portion of liquid to move from the reservoir 6 to the outlet 8′ and to be dispensed from the same.

FIG. 5 shows an exploded diagram of the apparatus shown in FIGS. 1a-g, with the reference numerals indicating the various component parts. It will therefore be appreciated from FIGS. 1a-g and 5 that as the power source batteries 25 are provided within a housing 19 which is only accessible via an opening on the underside 21 of the base, the power source and connection are physically remote from the liquid reservoir and remote from any flow of liquid which may occur. As a result, the liquid from the reservoir cannot access the housing and the connections between the power source and motor at the dispensing means. The sensing means are entirely housed within the product and are protected from liquid ingress. This advantage is greatly significant in comparison with the disadvantage of longer connection wires required between a remote power source and a sensing means and dispensing means.

Body 4 can be provided to be self standing on feet 18 which also serve to space housing 19 from a support surface and prevent any liquid on the surface from entering the housing.

Access can be gained to reservoir 6 via an opening at the top which is normally covered by lid 23. However, the lid need only cover the opening and not seal the same as the power sources are physically spaced from the same in accordance with the invention.

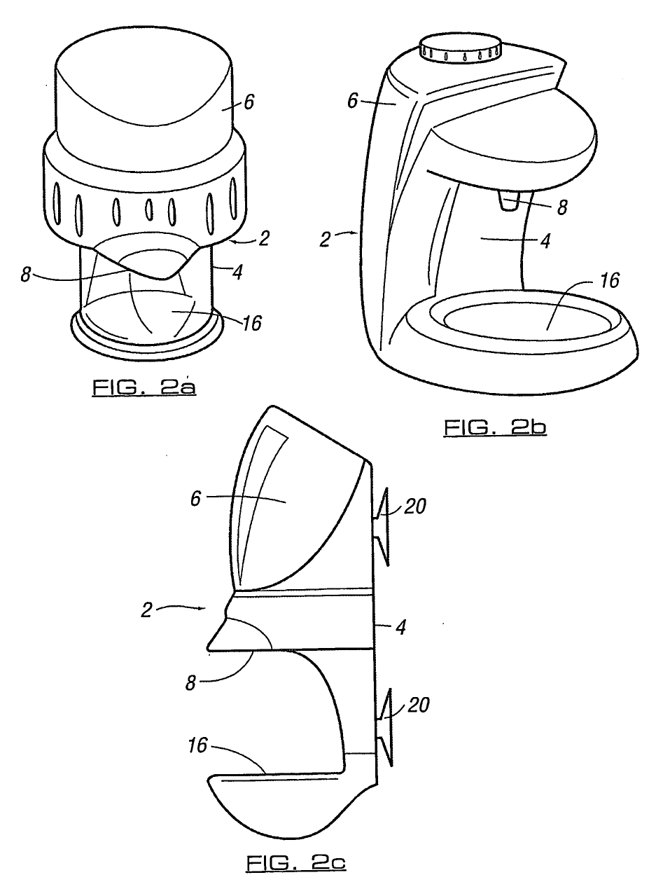

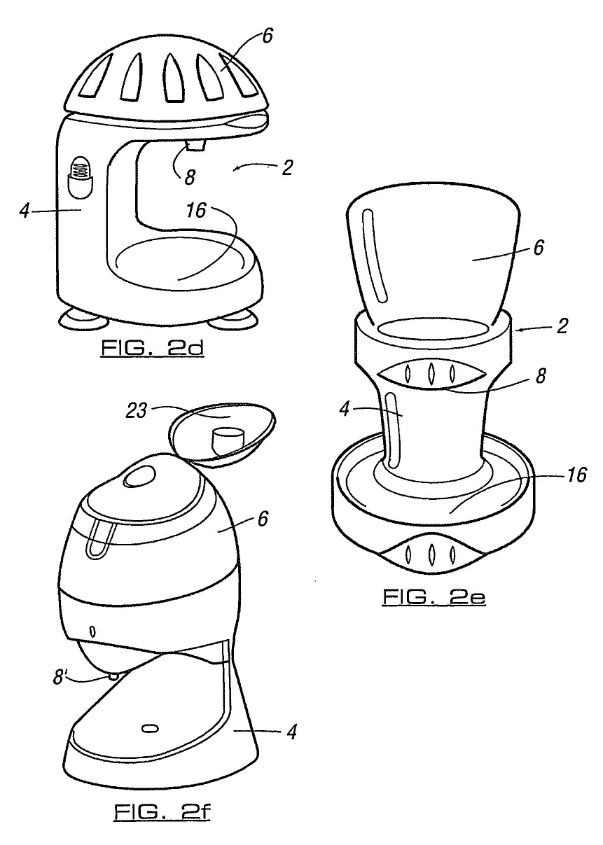

FIGS. 2a to g illustrate further examples of the apparatus 2 in accordance with alternative designs, and the same reference numerals are used as with FIGS. 1a-g to illustrate the same components.

It is shown in FIG. 2g how alternative mounting means to the feet 18 can be provided. In FIG. 2a suckers 20 are shown as being locatable on the body and, in turn, allow the apparatus to be located securely on a surface for use such as a shelf or a wall. Positioned in the base is a drip or collection means 16. This is provided to allow liquid which is dispensed and which is not collected by the hand to be held in a collection area, thereby allowing the same to be wiped away or alternatively for the tray to be removed and the liquid to be poured from the tray.

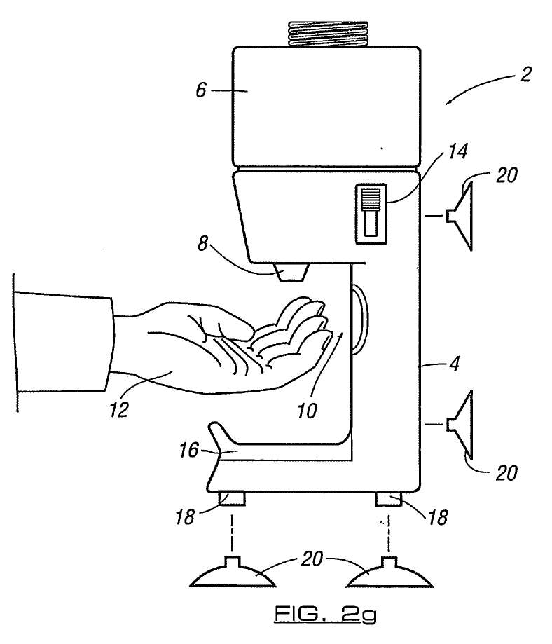

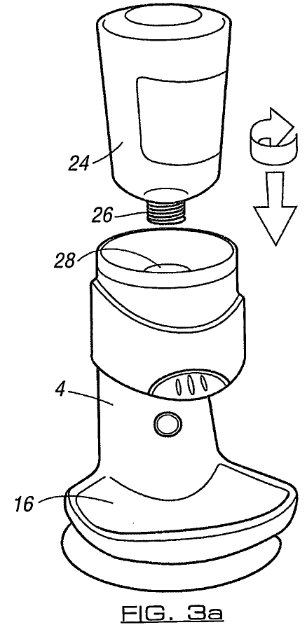

Turning now to FIGS. 3a-d, it will be appreciated that the provision of the liquid and the liquid reservoir can take one of several forms. In FIGS. 3a, c and d, there is shown an arrangement whereby the liquid, which is to be dispensed, is purchased in a container or bottle 24 from a retail outlet. The bottle or container is then opened, and an opening 26 in the bottle or container is then positioned in contact and in a sealed manner with an inlet 28 into the dispensing means of the body. This therefore means that the liquid held in the bottle or container 32 can be directly dispensed through dispensing means once the sensor activates the same, and hence the bottle or container 24 which has been purchased acts as the reservoir. Although this arrangement is perfectively effective in most instances, it may be the case that the user of the apparatus wishes to be able to use a particular liquid provided in a bottle or container with which the apparatus does not need to match and instead wishes to use a liquid which is provided in retail premises in a bottle or container 24 which does not match with the connection to the dispensing means. In this case, the arrangement shown in FIG. 3b is of benefit as there is provided a reservoir 6 as part of the apparatus. The liquid to be dispensed can be poured from the bottle or container 24 in which the same is purchased into the reservoir 6. It is reservoir 6 which is located on the dispensing means. This therefore means that the apparatus can be range taking in this embodiment as it is not dependent on the particular form of bottle or container in which the liquid is purchased.

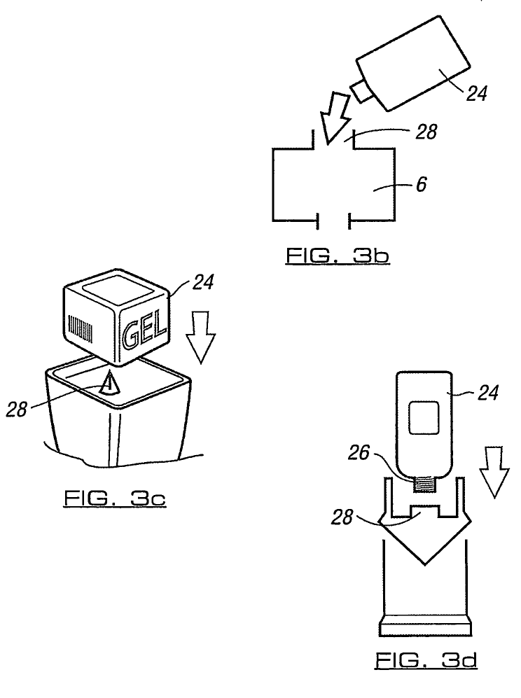

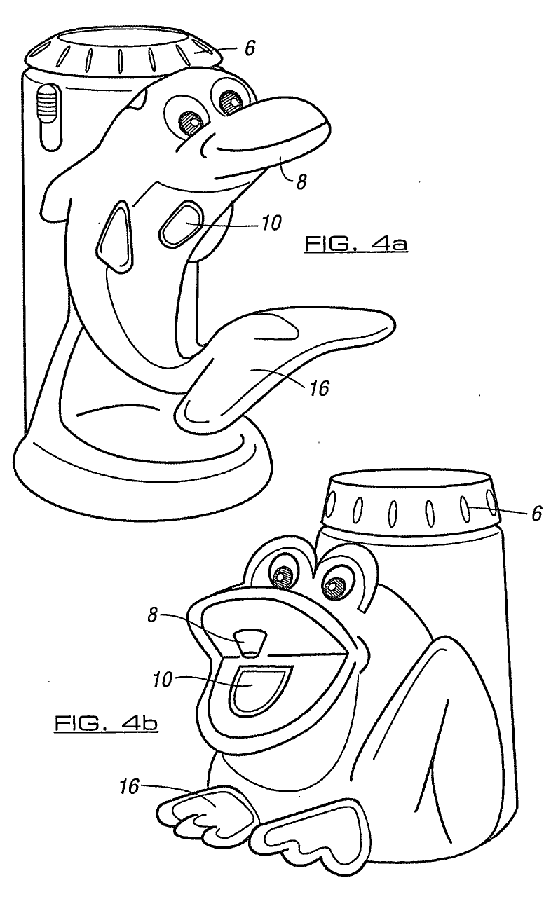

FIGS. 4a and b illustrate how the apparatus can be incorporated and designed to be particularly attractive to identifiable groups of users. With regard to FIGS. 4a and b, it is shown how the operation of the apparatus can be incorporated into character figures which provides licensing opportunities while, at the same time, provides a beneficial and effective apparatus.

Therefore the present invention provides apparatus which can be of use in encouraging children to wash more frequently as the apparatus is easier to use. In one embodiment, the apparatus dispensing means can include foaming means for the dispensed liquid, which can be of more fun and attractive to a child. When used by parents, for example in bathing of a child, the provision of the dispenser means that the parent's hands are available for a greater portion of the time to allow them to concentrate on controlling and bathing a child.

In further aspects of the invention, there is the ability to incorporate other features in addition to the simple dispensing of the liquid, when the sensor is activated. For example, additional audio or visual features can be provided which are also activated wherein the sensor detects the person's anatomy in the location of the apparatus.

1. Apparatus for the selective dispensation of a liquid, said apparatus comprising:
a base;
a reservoir of the liquid to be dispensed with is spaced from the base;
a dispenser through which a quantity of liquid can be dispensed from the reservoir into a dispensing region between the base and the reservoir;
a power source; and
and a sensor to control the dispensing of the liquid upon detection of a person and wherein the power source is provided at a position on the apparatus below the dispenser.

2. The apparatus according to claim 1 wherein said power source is provided within or adjacent to said base.

3. The apparatus according to claim 2 wherein said power source is located in a housing being accessible through an opening on a face of said base other than the face of said base which faces toward said dispenser.

4. The apparatus according to claim 1 wherein said power source is located in a housing remote from said liquid reservoir so as to prevent the liquid from contacting said power source.

5. The apparatus according to claim 1 wherein said power source is one or a plurality of batteries.

6. The apparatus according to claim 1 wherein said apparatus can be selectively activated and only when the apparatus is activated is the sensor active.

7. The apparatus according to claim 1 wherein said apparatus includes a dispenser adjuster which allows a user to select a quantity of the liquid which is dispensed on each occasion.

8. The apparatus according to claim 1 wherein said sensor detects the presence of part of a person's anatomy in said dispensing region and when a presence is detected, a quantity of the liquid, which is for use in cleaning part of the person's anatomy, is dispensed.

9. The apparatus according to claim 8 wherein said sensor is an infrared sensor which detects the presence of heat generated by the presence of a part of a person's anatomy within a given range of said sensor.

10. The apparatus according to claim 8 wherein said sensor includes a first part mounted at one side of said dispensing region and a second part mounted on an opposing side of the dispensing region and when a part of the person's anatomy is positioned between the first and second parts, a detection is made and dispensation of a portion of the liquid occurs.

11. The apparatus according to claim 1 wherein a controller is provided for the dispenser to ensure that a quantity of liquid is dispensed for a predetermined period of time.

12. The apparatus according to claim 1 wherein a controller is provided for the dispenser which ensures that a particular volume of liquid is dispensed.

13. The apparatus according to claim 1 wherein once said sensor has been activated and a portion of liquid dispensed, a time interval is required to elapse before a further quantity of liquid can be dispensed.

14. The apparatus according to claim 1 wherein said liquid reservoir is provided with an aperture at an upper face of the reservoir, the aperture being enclosed by a lid which can be selectively opened to gain access to the reservoir.

15. The apparatus according to claim 1 wherein said reservoir can be refilled in situ.

16. The apparatus according to claim 1 wherein said reservoir can be detached from the apparatus and replaced with a further reservoir.

17. The apparatus according to claim 15 wherein said reservoir can be removed from said apparatus to be refilled at a location remote from the apparatus and then moved back into position.

18. The apparatus according to claim 16 wherein said reservoir is filled under factory conditions and is purchased as a refill unit.

19. The apparatus according to claim 1 wherein said apparatus includes a drip or collection tray positioned on the base to act as a collector for excess liquid which has been dispensed and not used on the person's anatomy.

20. The apparatus according to claim 1 further includes attachments to allow a selective attachment of said apparatus via the base and/or side walls to locate said apparatus in position for use.

21. The apparatus according to claim 20 wherein said attachments are in the form of one or more suckers.

22. The apparatus according to claim 1 wherein operation of said sensor causes visual and/or audible features to operate.

23. The apparatus according claim 22 wherein operation of the visual and/or audible features is in addition to or instead of dispensing of the liquid from the reservoir.

24. The apparatus according to claim 1 further including a counter device to provide an indication of a number of uses for the apparatus.

25. An apparatus for selective dispensation of a liquid of a type to aid cleaning a part of a person's anatomy, said apparatus comprising:
a reservoir of the liquid to be dispensed;
a dispenser through which a quantity of the liquid can be dispensed;
a power source; and
a sensor to control the dispensing of the liquid in response to a user's presence being detected to allow the liquid to be dispensed onto the person for use.

26. An apparatus for dispensing a liquid for the cleaning of part of a person's anatomy, said apparatus comprising:
a base;
a reservoir of the liquid to be dispensed;
a dispenser through which a quantity of liquid can be dispensed from the reservoir;
a power source; and
a sensor to control the dispensing of the liquid upon detection of the presence of a part of a person's anatomy in a dispensing region for the liquid and wherein the power source is provided within or adjacent to said base.
